(19) United States
(12) Patent Application Publication
(10) Pub. No.: US 2018/0264379 A1
(43) Pub. Date: Sep. 20, 2018

(54) Method and Device for the Fast Extraction of Chemicals in a Substrate Using a Hydrocarbon Solvent

(71) Applicant: Linden Noble, Guelph (CA)

(72) Inventor: Linden Noble, Guelph (CA)

(21) Appl. No.: 15/459,989

(22) Filed: Mar. 15, 2017

(51) Int. Cl. B01D 11/04

(52) U.S. Cl. CPC B01D 11/0484; B01D 2011/007

(57) ABSTRACT

A device and method for extracting a solute from a substrate using a hydrocarbon solvent is disclosed. The device includes a storage tank for storing solvent at temperature T1 and pressure P1, with T1 and P1 below the boiling point. A material column is included for holding the substrate and a compression pump to pump the solvent from the storage tank to the material column at a second pressure P2 to leach the substrate material of solute, P2 being higher than P1. A collection vessel is included for receiving the solvent/solute solution. The collection vessel being configure to separate the solute from solvent by raising the solution to a second temperature T2 above the boiling point of the solvent. A heat exchanger for liquefying the solvent gas before the solvent is transferred back to the storage tank.

### FIELD OF THE INVENTION

The invention relates generally to methods and devices for extracting chemicals from plant material using hydrocarbon solvents.

### SUMMARY OF THE INVENTION

The present invention is directed at a method of extracting a solute from a substrate material using a hydrocarbon solvent. The method includes the steps of providing a storage tank for holding a quantity of the solvent at a first temperature T1 and a first pressure P1, with T1 and P1 being selected to keep the solvent in its liquid state. A material column is provided for holding a quantity of the substrate material containing the solute. A first compression pump is provided for pumping the liquid solvent from the storage tank and delivering the liquid solvent to the material column at a second pressure P2 sufficient to pass the liquid solvent through the substrate material in the material column so as to infuse the flow of liquid solvent with the solute, P2 being higher than P1. Transferring the infused liquid solvent which has passed through the material column to a collection vessel. The solute is then separated from the solvent in the collection vessel by raising the temperature of the infused solvent in the collection vessel to a second temperature T2 which is above the boiling point of the solvent to draw off the solvent as a gas. The solvent gas is then liquefied by cooling the solvent gas, which is then transferred back to the storage tank.

The invention is also directed towards a device for extracting a solute from a substrate material using a hydrocarbon solvent. The device includes a storage tank for holding a quantity of solvent. The storage thank has an output port and an input port. The storage tank is configured to hold the solvent at a first temperature T1 and a first pressure P1, with P1 and T1 being selected to keep the solvent in a liquid state. A first material column is provided for holding a quantity of substrate containing the solute, the material column having an input port and an output port. A first compression pump is coupled between the output port of the storage tank and the input port of the first material column. The first compression pump is configured to raise the pressure of the liquid solvent from P1 to a higher second pressure P2 sufficient to drive the solvent liquid through the substrate in the material column. The material column being configured to ensure leaching of the solute into the solvent to form a leach solution as the solvent passes between the input and output ports of the material column. A collection vessel is included having an input port, a liquid output port and a gas output port. The input port is coupled to the output port of the material column. The collection vessel is configured to raise the temperature of the leach solution entering the collection vessel to a temperature T2 sufficient to boil away the solvent while leaving the solute behind. Finally, the device includes a second pressure pump and a heat exchanger for drawing solvent gas from the collection vessel, cool it down back into a liquid and return the liquid coolant back to the storage tank.

### BRIEF DESCRIPTION OF THE DRAWINGS

FIG. 1 is a schematic view of a solute extraction system made in accordance with one aspect of the present invention;

FIG. 2 is a schematic view of the storage tank portion of the system shown in FIG. 1;

FIG. 3 is a schematic view of the first pressure pump portion of the system shown in FIG. 1;

FIG. 4 is a schematic view of the heat exchanger portion of the system shown in FIG. 1;

FIG. 5 is a schematic view of the material column portion of the system shown in FIG. 1;

FIG. 6 is a schematic view of the collection vessel portion of the system shown in FIG. 1;

FIG. 7 is a schematic view of the desiccator portion of the system shown in FIG. 1, and

FIG. 8 is a schematic view of the second compressor pump portion of the system shown in FIG. 1.

### DETAILED DESCRIPTION

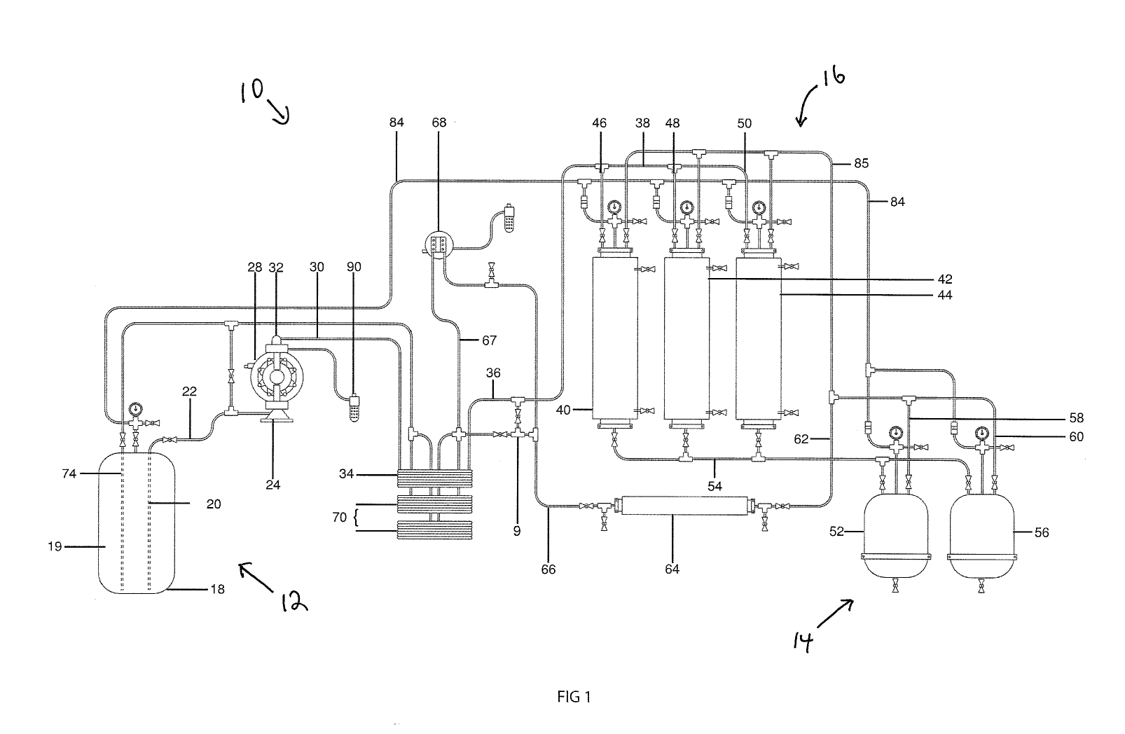

Referring firstly to FIG. 1 a device for carrying out the extraction of chemical solutes from plant based substrates using a volatile hydrocarbon solvent is shown generally as item 10 and has essentially three zones, namely a low pressure zone 12 where the hydrocarbon solvent is recaptured and stored at a relatively low pressure P1 and at a relatively low temperature T1, a high pressure zone 14 where the solvent exists primarily as a gas at an elevated pressure P2 and an elevated temperature T2, and an extraction zone 16 wherein the substrate is leached with the hydrocarbon solvent in its liquid state at a temperature T3 to extract the solute from the substrate. It will be noted that, depending on the hydrocarbon solvent used, P1 may be higher than normal atmospheric pressure depending on the ambient air temperature or dependant on T1. Preferably, P1 and P2 will be in the range of between 5 and 10 psi in the case of Butane and temperatures T1, T2 and T3 will preferably range between about −70° C. to about 40° C. To ensure a fast leaching of the solute from the substrate, T3 should preferably be maintained at a level necessary to keep the solvent at a highly fluid but still liquid state below the solvent's boiling point. In the case of butane, that temperature is preferably in the range of −40° C. to −20° C.

Low pressure zone 12 principally consists of storage tank 18 where a quantity of liquid solvent 19 is stored. Storage tank 18 is generally kept at a temperature T1 and a pressure P1 selected to keep the solvent in its liquid state. P1 will preferably be held at close to atmospheric pressure and T1 will preferably be held at close to −20° C. If the ambient atmospheric temperature and pressures are not sufficient to keeping the solvent in its liquid state, then tank 18 may be operatively coupled to heating or cooling mechanisms configured to keep the content of tank 18 within the desired temperature and pressure range. Such heating and cooling mechanisms are known generally in the art. In the present embodiment, the solvent in tank 18 can be passed through heat exchanger 34 and fed back to tank 18 by shunt line 9. Feed tube 20 taps the bottom of tank 18 and is coupled to solvent line 22 which is in turn coupled to input port 24 of pressure pump 28. Pressure pump 28 is in turn coupled to solvent line 30 via output port 32.

Solvent line 30 is coupled to a heat exchanger 34 where the temperature of the solvent is adjusted to T3 before being carried by solvent line 36 to input header 38. Input header 38 is coupled to material columns 40, 42 and 44 via solvent lines 46, 48 and 50, respectively. Material columns 40, 42 and 44 are coupled to collection tanks 52 and 56 via solvent line 54.

Material columns 40, 42, and 44 each hold a quantity of substrate which is to be leached by the solvent. The rate of flow of solvent through the material columns is dependant on many factors, not least of which is how densely the substrate is packed into the material columns. The more densely packed the substrate is, the more resistance to the flow of solvent. Pressure pump 28 is a positive displacement pump which effectively raises the pressure of the solvent from P1 to a higher pressure sufficient to pump the solvent through material columns 40, 42 and 44 and out through solvent line 54 to collection tanks 52 and 56 even if the substrate is densely packed in the material columns. The use of a positive displacement pump to actively pump the solvent through the material columns is a significant improvement as it ensures a higher rate of solvent flow through the material columns, and therefore, a higher rate of solute extraction and a greater amount of substrate which can be packed into the material columns.

Heat exchanger 34 is configured to adjust the temperature of the solvent reaching the material columns to T3 which can be carefully selected to maximize the extraction of the desired solute. It will be appreciated that the substrate contained in material columns 40, 42 and 44 will have a plurality of solutes, each of which may have a distinct solubility in the solvent depending on the solvent's temperature. Hence, by adjusting T3 the solutes being extracted from the substrate can be selected so that different quantities of solutes are extracted relative to others. In this way, device 10 can selectively extract more of one solute and less of another simply by adjusting T3.

The solvent passing through material columns 40, 42 and 44 becomes infused with the solute leached from the substrate material contained in the material columns and then passes through solvent line 54 and then empties into collection vessels 52 and 56. Collection vessels 52 and 56 are held at a temperature T2 which is well above the boiling point of the solvent but well below the boiling point of the solute. For most applications, T2 will be between 30° C. to 40° C. At T2 the solvent in the collection vessels boils into a gas resulting in a high pressure P2 subsisting within pressure vessels 52 and 56. The solvent now exits pressure vessels 52 and 56 as a hot gas via lines 58 and 60, respectively. Lines 58 and 60 couple to line 62 which pass to desiccators 64 which is configured to remove moisture from the solvent gas. The solvent gas leaves desiccators 64 via line 66 and passes to compression pump 68 which is coupled to heat exchanger 70 via line 67. Heat exchanger 70 cools the solvent gas to a temperature below its boiling point, thereby converting the solvent back into a liquid. Pump 68 helps to draw solvent out of desiccators 64 and also helps to compress the solvent gas thereby assisting the solvent to phase change back into a liquid. When the solvent is cooled sufficiently in heat exchanger 70 to turn liquid again, it is carried by line 72 and pipe 74 back into storage tank 18 to complete the circuit. The solute which is left as a liquid in collection vessels 52 and 56 can be drawn out from the bottom of the vessels as required. The arrows indicate the flow of solvent through the circuit.

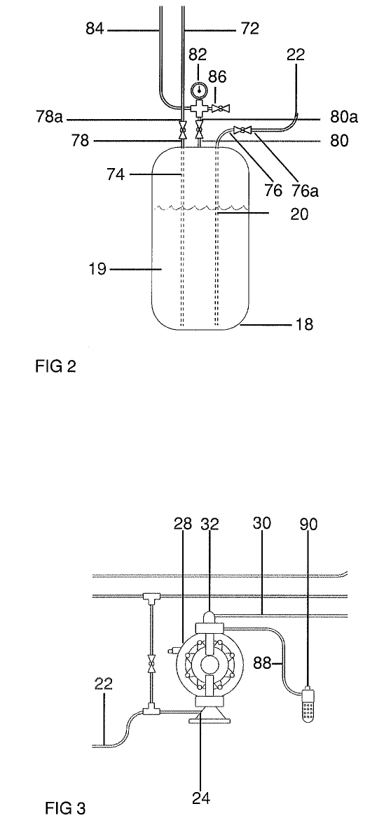

Referring now to FIG. 2, storage tank 18 consists of a large tank made of a strong material such as stainless steel which is adapted to store the preferred hydrocarbon solvent. Two pipes, 20 and 74 are coupled to output port 76 and input port 78, respectively. Valves 76a and 78a are provided at ports 76 and 78 respectively. A venting port 80 in combination with valve 80a is provided for venting gaseous solvent from vent line 84. Emergency exhaust valve 86 is provided for emergency pressure release. Pressure gauge 82 is provided to permit an operator to monitor the pressure within storage tank 18. As mentioned above, tank 18 is maintained at a temperature T1 at or near −20° C. during operation and a pressure P1 at or near atmospheric pressure and preferably below 5 psi.

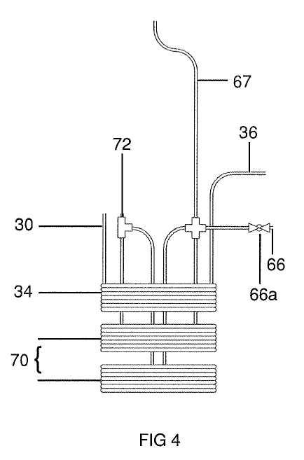

Referring now to FIG. 3, pressure pump 28 is a positive displacement pump configured to pump liquid across a pressure gradient. Preferably pump 28 consists of a pneumatically operated double diaphragm positive displacement pump. Filter regulator 90 is coupled to pump 28 by line 88 and is used to control the pump which controls the flow of air driving the pump. Pump 28 positively displaces the liquid solvent and forces it to flow against the pressure gradient formed between P1 and P2 permitting a high flow rate of liquid solvent through solvent line 30.

Referring now to FIG. 4, heat exchangers 34 and 70 preferably consist of separate coils of tubing which are configured to exchange heat from the contents of the tube and the outside of the tube. The coils are preferably placed, either separately or all together, in a cooling bath and cooled by means of water and ice, ethanol and dry ice, liquid nitrogen or by other cooling means known generally in the art. The coils forming heat exchanger 34 may be placed in a separate bath which is configured to adjust the temperature of the solvent flowing in the tubes to temperature T3. The temperature of the coils forming heat exchanger 70 are cooled to a temperate well below the boiling point of the solvent, which can be accomplished by placing said coils in baths of water/ice, ethanol/dry ice, liquid nitrogen or the like. Valve 66a can be used to control the flow of solvent gas through line 66. Heat exchanger 70 may include a plurality of separate parallel coils as may be needed to ensure fast liquefaction of the solvent gas.

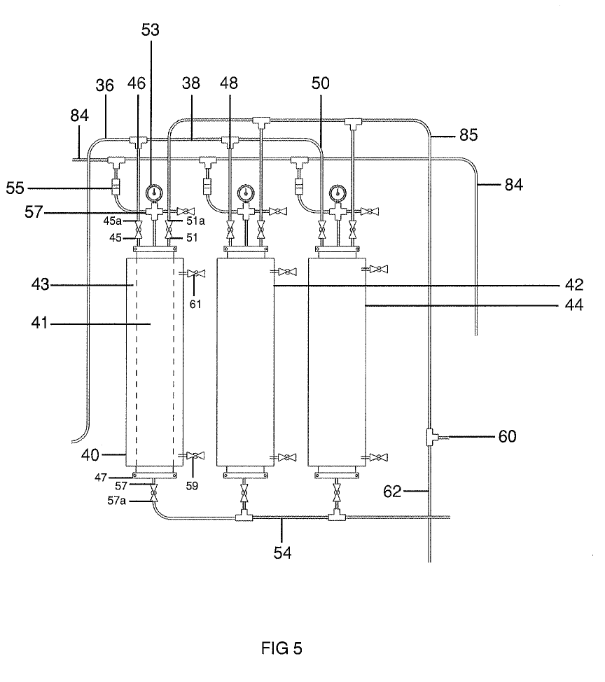

Referring now to FIG. 5, material columns 40, 42 and 44 together form a material leaching station wherein the substrate is leached of solute at a cold temperature below the boiling point, which in the case of butane is between about −40° C. to about −20° C. For the sake of brevity, details of only one material column, namely column 40, will be discussed in detail; however, each of the material columns is identical and has the same construction. Material column 40 includes a central cylindrical column 41 contained within a thermal jacket 43. Cylindrical column 41 has end caps 45 and 47 which are fixed to the opposite ends of cylindrical column 41 and sealed to prevent leakage of solvent. Cap 45 has an intake port with valve 45a coupled between the intake port and solvent line 46 branching off header 38. Cap 45 also has gas port 51 coupled to vent line 85 via valve 51a to vent any solvent in its gas state to prevent overpressure developing in the material column. Another port 57 is provided on cap 45 to couple to pressure gauge 53 to monitor the pressure inside the material column, Release valve 55 is coupled between port 57 and line 84 to release solvent back towards the storage tank in the event the pressure within material column 40 exceeds a pre-determined upper limit. Cap 47 has an output port 57 with an output port valve 57a coupled between the output port and solvent line 54. Cap 47 adjacent output port 57 would include filtering elements to ensure that particulate matter from the substrate contained in material column 40 are not carried with the solvent as it passes output port 57. As mentioned above, each column includes a thermal blanket 43 which envelops the cylindrical column 41 and is used to regulate the temperature within the material column. Valves 59 and 61 are coupled to a flow of heating fluid (not shown) to control the temperature of thermal blanket 43. Alternatively, if a colder temperature is required, a colder fluid such as liquid CO₂ can be used to control the temperature of thermal blanket 43.

The material columns 40, 42 and 44 are arranged in parallel in the leaching station with each material column being coupled to the circuit by a plurality of valves as discussed above. The material columns are each fed with fresh liquid solvent from a common header 38, and each material column is coupled to solvent line 54 for receiving the solvent containing the solute. The various valves allow each individual material column to be isolated from the rest of the circuit and the other material columns, simply by closing all of the valves located at the material column. This ability to independently isolate each material column from the circuit permits an easy way of removing the material column from the leaching station without interrupting the operation of the entire device. A material column which has been depleted of solute can therefore be easily removed from the circuit, recharged with fresh substrate and then re-introduced into the circuit without interrupting the device; thereby providing for continuous operation of the device.

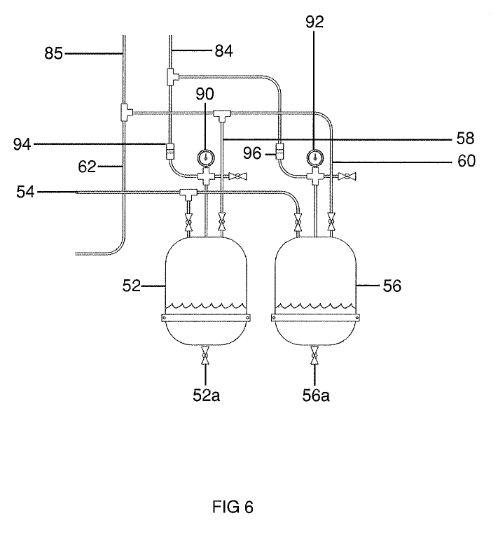

Referring now to FIG. 6, solvent saturated with the solute passes through solvent line 54 and empties into receiving tanks 52 and 56. Tanks 52 and 56 are held at a temperature T2 which above the boiling point of the solvent used but below the boiling point of the solute extracted. In the case of butane, T2 is preferably in the range of between about 30° C. to about 40° C. yielding a pressure within the tanks P2 of about 5 to 25 psi. The solute in its liquid state is drawn away from tanks 52 and 56 through valves 52a and 56a. The solvent in the tanks is rendered into a gas which passes through gas lines 58 and 60 to line 62. Since lines 58, 60 and 62 are intended to carry the solvent in its gas state, one would assume that these gas lines must have a significantly higher internal diameter than the lines intended to carry the solvent in its liquid state, like solvent line 54. However, it has been discovered that this is not the case with the present design. Surprisingly, it has been discovered that the present design provides for efficient and high rates of extraction if all of the solvent lines, regardless if they are transporting solvent in its liquid or gaseous state, are of the same internal diameter. Ideally the internal diameter of the conduits should be about ½ inch in the case of a butane solvent. This simplifies both the construction and the maintenance for the device as only one size of conduit and fittings are required. Pressure gauges 90 and 92 are coupled to tanks 52 and 56 to monitor the pressure within the tanks so as to ensure that the tanks remain at pressure P2. Pressure relief valves 94 and 96 are configured to carry excess solvent out of tanks 52 and 56, respectively, to line 84 in the event P2 exceeds a predetermined upper threshold.

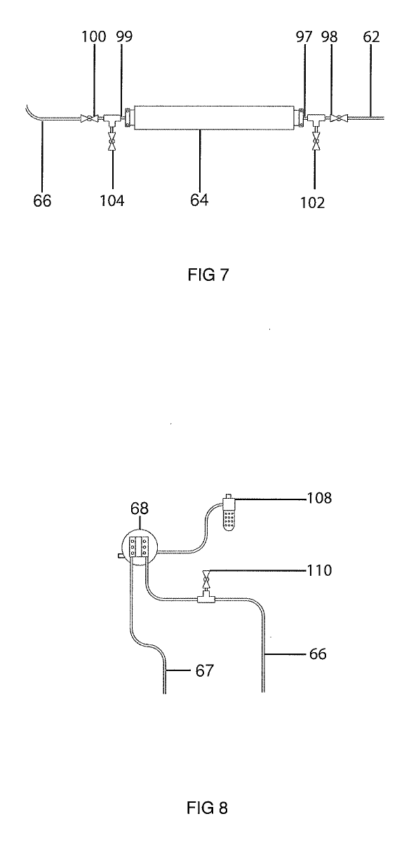

Referring now to FIG. 7, desiccator 64 is coupled to solvent gas line 62 at input port 97 by valve 98. Output port 99 of desiccator 64 is coupled to solvent gas line 66 by valve 100. Valves 102 and 104 are provided for venting purposes. Desiccator 64 is preferably a sanitary spool filled with a molecular sieve, but other desiccator designs could be adapted, such as ones consisting of silica gel, lime, or any other desiccating agent adapted to remove moisture from the solvent gas. Numerous desiccators which could be adapted for use in the present invention are commercially available.

Referring now to FIG. 8, pressure pump 68 is used to assist in driving gaseous solvent through the circuit during or immediately before a change over of one of the material columns to draw residual solvent from the material column before its replacement. Pressure pump 68 is preferably a pneumatic pump which operates to draw gaseous solvent out of the desiccator (FIG. 7) and into the cooling coils of the heat exchanger 70 (FIG. 4). Air passing through pressure pump 68 is controlled by filter regulator 108. Suitable pneumatic pressure pumps are generally available in the market. During normal operation, pressure pump 68 is not engaged.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art.

What is claimed is:

1. A method for extracting a solute from a substrate material using a hydrocarbon solvent, the method comprising:
providing a storage tank for holding a quantity of solvent at a first temperature T1 and a first pressure P1, T1 and P1 selected to keep the solvent in a liquid state;
providing a material column for holding a quantity of the substrate material containing the solute;
providing a first compression pump for pumping the liquid solvent from the storage tank at a second pressure P2 through the substrate material in the material column to infuse said flow of solvent with the solute, P2 being higher than P1;
providing a collection vessel;
transferring the infused liquid solvent which has passed through the material column to said collection vessel;
separating the solute in a liquid form from the solvent in a gaseous form in the collection vessel by raising the temperature of the infused solvent in the collection vessel to a second temperature T2, T2 being above the boiling point of the solvent;
liquefying the solvent in the gaseous form by cooling the solvent back down to T1, and transferring the liquefied solvent back to the storage tank.

2. The method of claim 1 further comprising the step of passing the liquid solvent through a heat exchanger after pumping the liquid solvent through the first compression pump and before passing the liquid solvent through the material column to keep the temperature of said solvent at a third temperature T3 as the solvent passes through the material column, T3 being lower than T2.

3. The method of claim 1 further comprising the step of desiccating the gaseous solvent from the collection vessel before liquefying it by cooling.

4. A device for extracting a solute from a substrate material using a hydrocarbon solvent in a circuit, the device comprising:
a storage tank for holding a quantity of solvent, the storage tank having an output port and an input port, the storage tank being configured to hold the solvent at a first temperature T1 and first pressure P1, P1 and T1 being selected to keep the solvent in a liquid state;
a first material column for holding a quantity of substrate containing the solute, the material column having an input port and an output port;
a first compression pump coupling the output port of the storage tank to the input port of the material column, the first compression pump configured to raise the pressure of the solvent from P1 to a higher second pressure P2 and deliver the solvent at P2 to the input port of the material column, the first material column being configured to ensure leaching of the solute into the solvent to form a leach solution as the solvent passes between the input and output ports of the material column;
a collection vessel having an input port, a liquid output port and a gas output port, the input port of the collection vessel coupled to the output port of the first material column, the collection vessel configured to raise the temperature of the leach solution entering the collection vessel to a temperature T2, T2 being selected to be higher than the boiling point of the solvent component of the leach solution so as to separate the solvent from the solute in the collection vessel;
a desiccator having an input port and an output port, the dessicator adapted to dessicate solvent in the gas state, the desiccator coupled to the gas output port of the collection vessel, and
a first heat exchanger having an input port and an output port, the input port of the heat exchanger coupled to the output port of the desiccators, the output port of the heat exchanger coupled to the input port of the storage tank, the heat exchanger configured to adjust the temperature of the solvent in the liquid state to T1.

5. The device of claim 4 further comprising a second compression pump having an input port and an output port, the input port of the second compression pump coupled to the output port of the desiccator, the output port of the second compression port coupled to the input port of the first heat exchanger, the second compression pump configured to pull a vacuum on the circuit drawing gaseous solvent entrained in the substrate column.

6. The device of claim 5 further comprising a second heat exchanger coupled between the output port of the first compression pump and the input port of the material column, the second heat exchanger configured to adjust the temperature of the solvent exiting the second heat exchanger to a third temperature T3, T3 being lower than T2.

7. The device of claim 5 further comprising a second material column for holding a quantity of substrate containing the solute, the second material column having an input port and an output port, the input ports of the first and second material columns each being coupled to an input header by an input valve, the output ports of the first and second material columns each being coupled to an output header by an output valve, the input header being coupled to the output port of the first compression pump and the output header being coupled to the input port of the collection vessel, each of the first and second material columns being capable of decoupling from the input and output headers independent of each other by closing the input and output valves for said first and second material column being decoupled.

8. The device of claim 5 further comprising a first and second plurality of conduit lines, the first plurality of conduit lines carrying the solvent in its liquid state from the storage tank, through the first compression pump, input header, material columns, and output header to the collection vessel, the second plurality of conduit lines carrying the solvent from the collection vessel, desiccators, second compression pump to the storage tank, the first and second plurality of conduit lines having an internal diameter, the internal diameter of the second plurality of conduit lines being equal to the internal diameter of the first plurality of conduit lines, the internal diameter of the first and second plurality of conduit lines being ½ inch.
